(19) United States
(12) Patent Application Publication
(10) Pub. No.: US 2026/0126781 A1
(43) Pub. Date: May 7, 2026

(54) DATA MAPPING METHOD, DATA MAPPING SYSTEM, AND ROBOT MONITORING SYSTEM

(71) Applicant: SEIKO EPSON CORPORATION, Tokyo (JP)

(72) Inventor: Eiichi OHARA, MATSUMOTO-SHI (JP)

(21) Appl. No.: 19/376,747

(22) Filed: Oct. 31, 2025

(30) Foreign Application Priority Data
Nov. 1, 2024 (JP) 2024-192736

(51) Int. Cl. G05B 19/418

(52) U.S. Cl. CPC G05B 19/4183; G05B 19/4185

(57) ABSTRACT

A data mapping method includes an acquisition step and a mapping step, the mapping step includes when a first condition is satisfied, configuring a storage section in a memory section based on, among association information associating a plurality of sets of information with a plurality of storage locations for each type of a device with respect to a part of the device, the association information corresponding to the type of the device represented by the type information included in device data, and when a second condition is satisfied, configuring the storage section in the memory section based on the data structure included in the acquired device data, the first condition includes that the memory section stores the association information, and the second condition includes that the memory section does not store the association information.

### CROSS-REFERENCE TO RELATED APPLICATIONS

The present application is based on, and claims priority from JP Application Serial Number 2024-192736, filed November 1, 2024, the disclosure of which is hereby incorporated by reference herein in its entirety.

### BACKGROUND OF THE INVENTION

### 1. Technical Field

The present disclosure relates to a data mapping method, a data mapping system, and a robot monitoring system.

### 2. Related Art

In recent years, management systems for factories using IT technology are developed. More specifically, the management system collects information on equipment used in factories and performs visualization of an operating status of the equipment based on the collected information. The management system is also called a cyber physical system (CPS) or an Internet of Things (IoT) system. Hereinafter, the equipment used in factories is also referred to as a "device".

The information collected by the management system is stored in, for example, a database constructed in a server on a network. In order to store the collected information in the database, a user determines a storage location of the collected information on the database in advance. Further, the user determines the storage location according to the type and use of the collected information.

JP-A-2023-43079 describes a technology for determining a candidate storage location among a plurality of storage locations referred to as a class and a property in a standard data model. In the technology of JP-A-2023-43079, when there are a plurality of candidate storage locations, the storage location selected by the user among the plurality of candidate storage locations is determined as the storage location of the collected information. In the technique of JP-A-2023-43079, as a method for detecting candidate storage locations, for example, it is detected whether or not a device name included in a schema name of data completely matches or partially matches an item name defined in the storage location. In the following, determining the storage location of the collected information is referred to as "mapping".

However, when the mapping work is performed by the user, the workload of the user increases depending on the type and amount of data to be collected. Further, the mapping work may require expert knowledge about the device. Therefore, even when the number of types of devices increases, the workload of the user involved in the mapping work increases. Therefore, a technique for reducing the burden of the mapping work is demanded.

### SUMMARY OF THE INVENTION

According to a first aspect of the present disclosure, there is provided a data mapping method of determining a plurality of storage locations for respectively storing a plurality of sets of information of device data in a data mapping system. In the data mapping method, the device data includes the plurality of sets of information related to a device and has a data structure configured to associate the plurality of sets of information with each other, the plurality of sets of information includes type information representing a type of the device, the data mapping method includes an acquisition step of acquiring the device data, by a control section included in the data mapping system, and a mapping step of configuring a storage section including the plurality of storage locations, the storage section having a storage structure configured to associate the plurality of storage locations with each other and storing the plurality of sets of information, in a memory section included in the data mapping system, by the control section, the mapping step includes, when a first condition is satisfied, configuring the storage section in the memory section based on, among association information associating the plurality of sets of information with the plurality of storage locations for each type of the device with respect to a part of the device, the association information corresponding to the type of the device represented by the type information included in the acquired device data, and when a second condition is satisfied, configuring the storage section in the memory section based on the data structure included in the acquired device data, the first condition includes that the memory section stores the association information corresponding to the type of the device represented by the type information included in the acquired device data, and the second condition includes that the memory section does not store the association information corresponding to the type of the device represented by the type information included in the acquired device data.

According to a second aspect of the present disclosure, there is provided a data mapping system that determines a plurality of storage locations for respectively storing a plurality of sets of information of device data. In the data mapping system, the device data includes the plurality of sets of information related to a device and has a data structure configured to associate the plurality of sets of information with each other, the plurality of sets of information includes type information representing a type of the device, the data mapping system includes a management section and an information aggregation section, the management section includes a control section and a memory section, the information aggregation section stores the device data by acquiring the plurality of sets of information from the device in advance, the memory section stores association information, the control section is capable of configuring, in the memory section, a storage section for storing the plurality of sets of information, the storage section includes the plurality of storage locations for respectively storing the plurality of sets of information and has a storage structure for associating the plurality of storage locations with each other, the association information associates the plurality of sets of information with the plurality of storage locations for each type of the device with respect to a part of the device, the control section acquires the device data from the information aggregation section, when a first condition is satisfied, configures the storage section in the memory section based on the association information corresponding to the type of the device represented by the type information included in the acquired device data, and when a second condition is satisfied, configures the storage section in the memory section based on the data structure included in the acquired device data, the first condition includes that the memory section stores the association information corresponding to the type of the device represented by the type information included in the acquired device data, and the second condition includes that the memory section does not store the association information corresponding to the type of the device represented by the type information included in the acquired device data.

According to a third aspect of the present disclosure, there is provided a robot monitoring system that determines a plurality of storage locations for respectively storing a plurality of sets of information of device data. In the robot monitoring system, the device data includes the plurality of sets of information related to a device and has a data structure configured to associate the plurality of sets of information with each other, the plurality of sets of information includes type information representing a type of the device, the device is a plurality of robots, the robot monitoring system includes a management section, an information aggregation section, and a display section, the management section includes a control section and a memory section, the information aggregation section stores the device data by acquiring the plurality of sets of information from the device in advance, the memory section stores association information, the control section is capable of configuring, in the memory section, a storage section for storing the plurality of sets of information, the storage section includes the plurality of storage locations for respectively storing the plurality of sets of information and has a storage structure for associating the plurality of storage locations with each other, the association information associates the plurality of sets of information with the plurality of storage locations for each type of the device with respect to a part of the device, the control section acquires the device data from the information aggregation section, when a first condition is satisfied, configures the storage section in the memory section based on the association information corresponding to the type of the device represented by the type information included in the acquired device data, when a second condition is satisfied, configures the storage section in the memory section based on the data structure included in the acquired device data, stores the plurality of sets of information in the storage section, and displays a screen that is capable of monitoring states of the plurality of robots, the screen being generated based on the plurality of sets of information stored in the storage section, on the display section, the first condition includes that the memory section stores the association information corresponding to the type of the device represented by the type information included in the acquired device data, and the second condition includes that the memory section does not store the assoc iation information corresponding to the type of the device represented by the type information included in the acquired device data.

### BRIEF DESCRIPTION OF DRAWINGS

FIG. 1 is an explanatory diagram illustrating a schematic configuration of a data mapping system.

FIG. 2 is an explanatory diagram illustrating an example of a data structure.

FIG. 3 is an explanatory diagram illustrating an example of a storage structure.

FIG. 4 is an explanatory diagram illustrating an example of association information.

FIG. 5 is a flowchart illustrating a data mapping method.

FIG. 6 is an explanatory diagram illustrating an example of acquisition interval information in a second embodiment.

FIG. 7 is a flowchart illustrating a data mapping method of the second embodiment.

FIG. 8 is a flowchart illustrating a data mapping method of a third embodiment.

FIG. 9 is a flowchart illustrating a data mapping method of a fourth embodiment.

FIG. 10 is a flowchart illustrating a data mapping method of a fifth embodiment.

FIG. 11 is an explanatory diagram illustrating a data mapping system of a seventh embodiment.

### DETAILED DESCRIPTION OF THE INVENTION

### A. First Embodiment:

### A-1. Configuration of System:

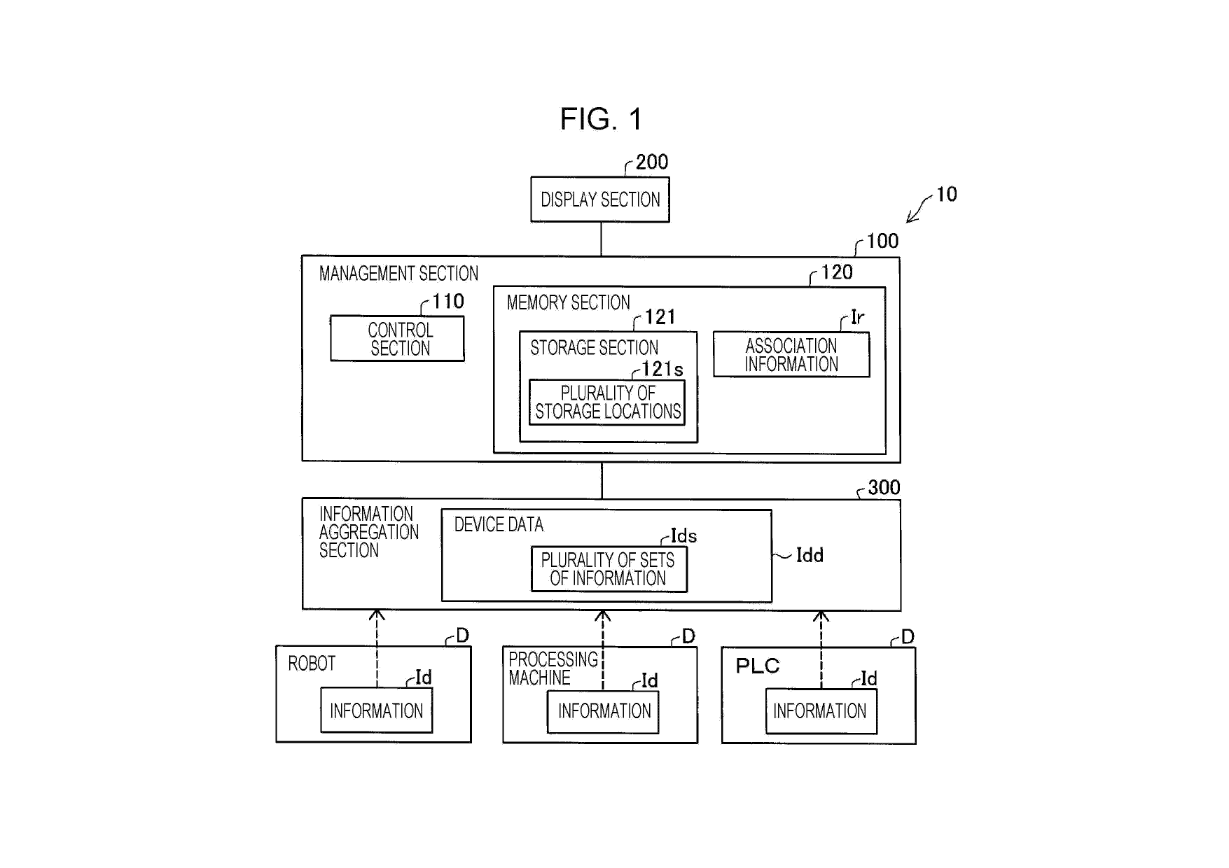

FIG. 1 is an explanatory diagram illustrating a schematic configuration of a data mapping system 10. The data mapping system 10 manages a plurality of sets of information Ids related to equipment used in a factory. The data mapping system 10 includes a management section 100, a display section 200, and an information aggregation section 300. In the following, the equipment used in the factory is referred to as a "device".

A device D outputs various pieces of information Id to be transmitted to the management section 100, which will be described later. The device D is, for example, a robot, a processing machine, a programmable logic controller (PLC), and the like. Further, the device D also includes an I/O board, a force sensor, and the like positioned as options. In addition, the device D includes equipment positioned as a child device. Specifically, the child device of a robot includes a shaft device, a camera in a Vision system, and the like.

The device D outputs various pieces of information Id to the information aggregation section 300. The various pieces of information Id include quantitative information that can be represented by numerical values and qualitative information for identifying the device D. For example, the robot may also output, as various pieces of information Id, a command value for controlling the robot, a measurement value acquired by a sensor included in the robot, power consumption of the robot, information for specifying the device D, such as the model of the robot, and information input to and output from the child device coupled to a controller, and the like.

The information aggregation section 300 stores device data Idd including the plurality of sets of information Ids.

The plurality of sets of information Ids are groups of information collected by being acquired from the device D. In the first embodiment, the plurality of sets of information Ids include type information Idt that represents the type of the device D.

The device data Idd includes the plurality of sets of information Ids related to the device D. Further, the device data Idd includes a data structure that associates the plurality of sets of information Ids with each other.

The information aggregation section 300 acquires the plurality of sets of information Ids from the device D in advance before a data mapping method, which will be described later, is executed. Further, the information aggregation section 300 generates the device data Idd including a data structure configured by associating storage destinations of the plurality of sets of information Ids with each other.

Specifically, the information aggregation section 300 is a server device. The information aggregation section 300 is configured by a computer including a processor, a ROM, a RAM, an auxiliary storage device, an input/output interface of various signals, and the like. However, in order to facilitate understanding of the technology, the configuration of the information aggregation section 300 is not illustrated in FIG. 1. The information aggregation section 300 is connected to the device D and the management section 100 in a communicable state. The information aggregation section 300 is, for example, an OPC UA server described below.

For the communication of the device data Idd, for example, OPC Unified Architecture (OPC UA) is used. The OPC UA is an open international standard that is established for reliable data exchange in the industry such as industrial automation. The communication of the OPC UA is performed by an OPC UA server that receives the information Id from the device D and an OPC UA client that is provided with the device data Idd from the OPC UA server. The OPC UA server stores the received information Id together with information referred to as an address space that associates the received information Id with the device D. As a result, the OPC UA server transmits the received information Id to the OPC UA client by referring to the address space in response to a request from the OPC UA client. As described above, in the present embodiment, the OPC UA server is the information aggregation section 300. The OPC UA client is the management section 100 which will be described later.

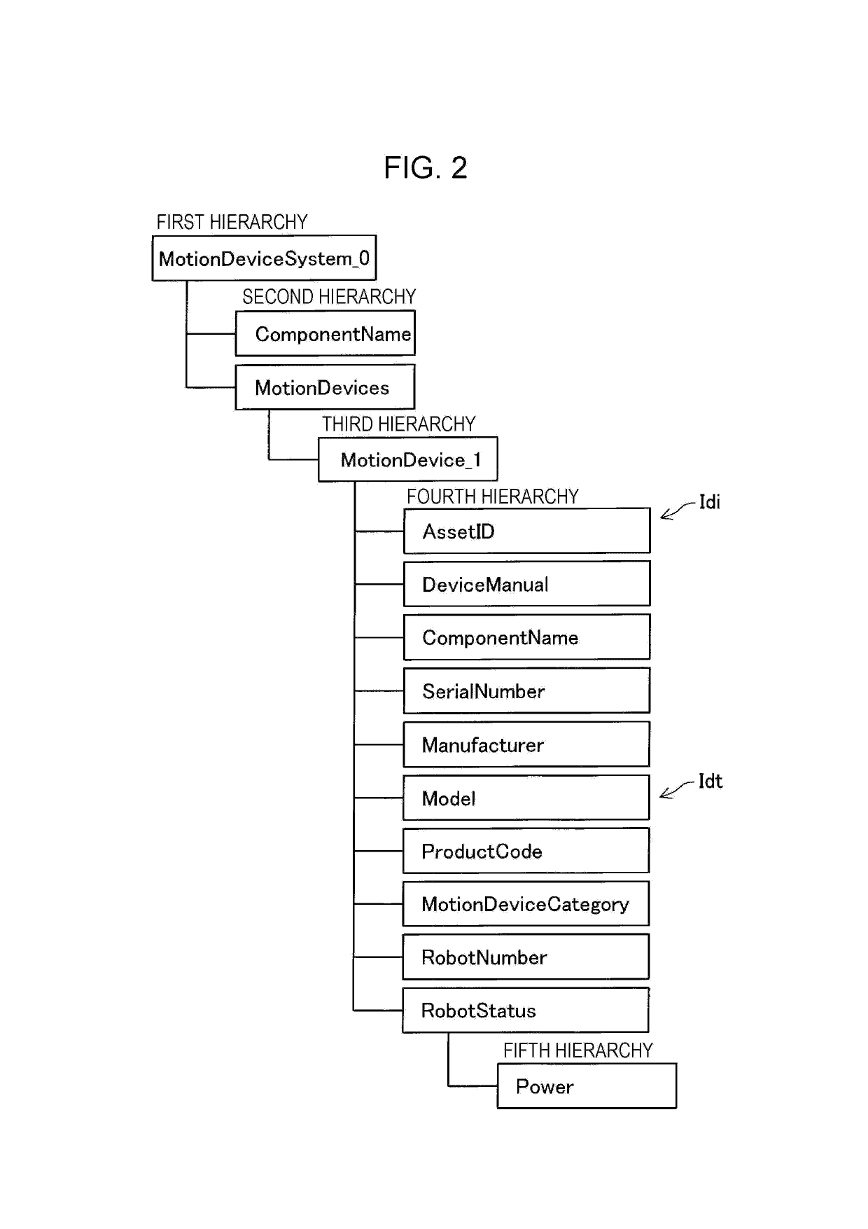

FIG. 2 is an explanatory diagram illustrating an example of the data structure. The address space of the OPC UA represents the data structure in a hierarchical type. In addition, the data structure includes a plurality of predetermined hierarchies. In the OPC UA, an information model for defining a plurality of sets of information Ids configured by a hierarchical data structure is defined for each industry. Such an information model is referred to as a "companion specification". An example of the data structure in FIG. 2 is constructed based on "OPC UA for Robotics", which is a companion specification targeting industrial robots and their peripheral equipment. Such an information model has a plurality of hierarchies. The storage destinations of the plurality of sets of information Ids in the information aggregation section 300 are represented by names such as "MotionDeviceSystem_0" in a first hierarchy, and "ComponentName" and "MotionDevices" in a second hierarchy, and the like. In order to facilitate understanding of the technology, the example of the data structure of FIG. 2 illustrates a part related to the robot in the information model of the OPC UA.

The above-described type information Idt is included in, for example, "Model" in the example of the data structure of FIG. 2. "Model" includes information Id that represents a model of the device D. For example, the information on the model included in "Model" represents the classification and the manufacturer of the device D.

The management section 100 manages the plurality of sets of information Ids related to the device D. As illustrated in FIG. 1, the management section 100 includes a control section 110, a memory section 120, and an input/output interface of various signals. In FIG. 1, in order to facilitate understanding of the technology, the input/output interface is not illustrated. The management section 100 communicates with the display section 200 and the information aggregation section 300 via the input/output interface. The management section 100 is the OPC UA client when the OPC UA is used for the communication of the device data Idd. Therefore, for example, the management section 100 includes a computer that acquires the device data Idd from the OPC UA server, and a cloud server that constructs a database for storing the plurality of sets of information Ids acquired by the computer. For example, the computer reads the plurality of sets of information Ids and the data structure for the device data Idd. The computer stores the plurality of sets of information Ids in a predetermined storage location in the database of the cloud server. That is, a storage device of the cloud server functions as the memory section 120. A control device of the computer and the cloud server functions as the control section 110. The management section 100 may be configured only by the cloud server, or may construct a database for storing the plurality of sets of information Ids by a computer that acquires the device data Idd.

The memory section 120 stores information required for managing the device data Idd. The memory section 120 is configured by a storage medium such as a semiconductor memory or a magnetic disk. The memory section 120 is a RAM, a ROM, and an auxiliary storage device for the control section 110 which will be described later. That is, the memory section 120 stores a program and data necessary for the control of the management section 100. Further, the memory section 120 stores the association information Ir. The association information Ir will be described later. In the memory section 120, a storage section 121 is configured by the control section 110.

The storage section 121 includes a plurality of storage locations 121s that respectively store the plurality of sets of information Ids. The plurality of storage locations 121s store the plurality of sets of information Ids of the device data Idd. That is, the plurality of storage locations 121s are a part of a region of the memory section 120 for storing the plurality of sets of information Ids.

The storage section 121 includes a storage structure that associates the plurality of storage locations 121s with each other. In the present embodiment, the storage structure is hierarchical.

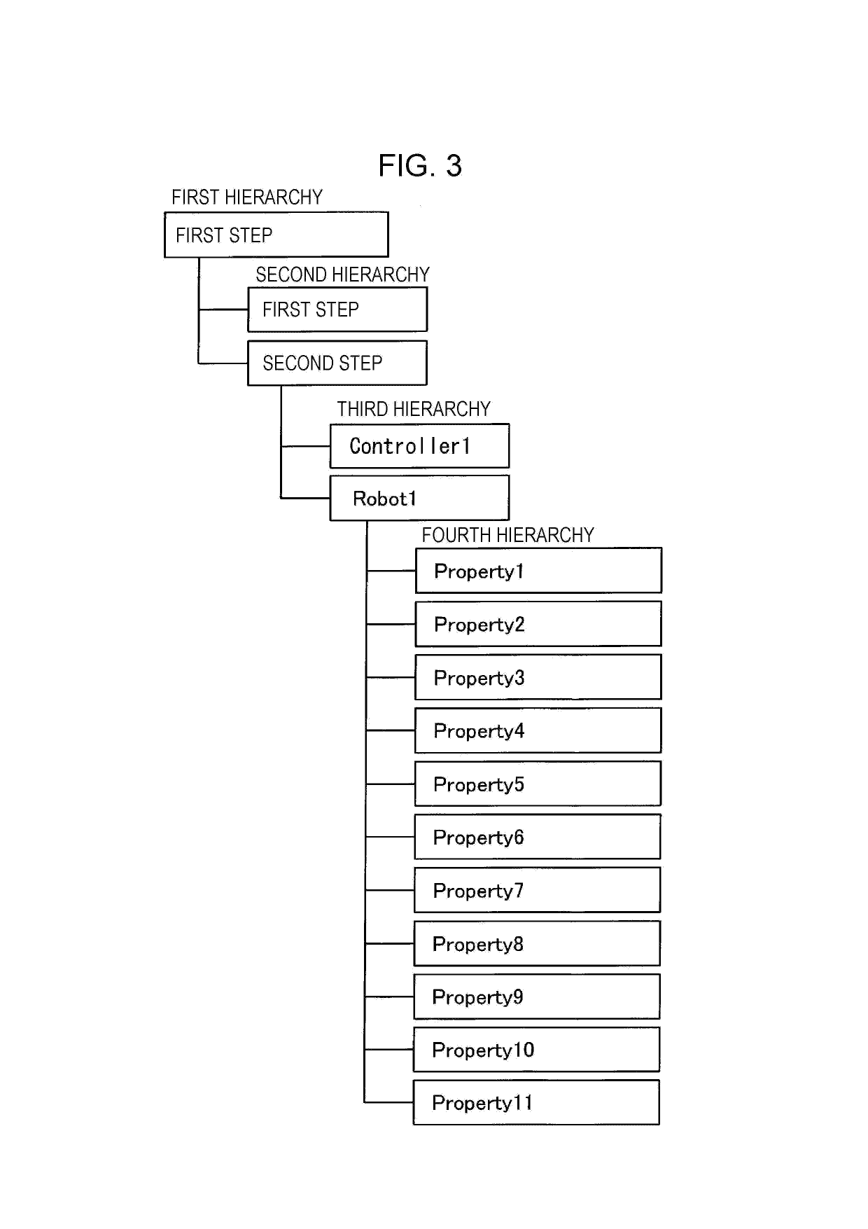

FIG. 3 is an explanatory diagram illustrating an example of the storage structure. The storage structure will be described with examples. The hierarchy of the storage structure is determined based on, for example, a division in which the device D is managed. For example, the device D used in a factory may be managed for each step in which each device D is used. In such a case, the storage structure has a parent hierarchy in which segments are divided for each step, for example. The parent hierarchy is the second hierarchy in FIG. 3. Further, the storage structure has a child hierarchy in which segments are divided for each type of the device D as a hierarchy linked to the segment of the parent hierarchy. "Controller1" represents a robot controller as the device D. "Robot1" represents a robot as the device D. The child hierarchy is a third hierarchy in FIG. 3. In addition, the storage structure has a grandchild hierarchy in which segments are divided into each storage location of the plurality of storage locations 121s, as a hierarchy linked to the segments of the child hierarchy. The grandchild hierarchy is a fourth hierarchy in FIG. 3. By determining the storage structure based on the division managed by the device D, the user of the device D can easily handle the storage section 121.

In the present embodiment, the storage structure is a hierarchical type, but the data structure may be a Relational DataBase (RDB) type or a network type.

The control section 110 controls the management section 100. The control section 110 is, for example, a microprocessor. The control section 110 controls the management section 100 by executing a control program of the memory section 120. The control section 110 can configure the storage section 121 for storing the plurality of sets of information Ids in the memory section 120. Specific functions of the control section 110 will be described in detail later.

The display section 200 displays information of the management section 100. More specifically, the display section 200 visually displays information that represents the storage section 121. The display section 200 is a terminal used by a user who manages the device D based on the plurality of sets of information Ids. For example, the display section 200 is a general-purpose computer. For example, the display section 200 displays the plurality of sets of information Ids on a browser of the general-purpose computer together with the visually represented storage structure. A web application for visually displaying information of the database through a browser may be used.

### A-2. Association Information:

The association information Ir associates the plurality of sets of information Ids and the plurality of storage locations 121s with each type of the device D for a part of the device D. The "with each type of the device D for a part of the device" will be described later. More specifically, the association information Ir associates a plurality of storage destinations of the plurality of sets of information Ids represented by the device data Idd with a plurality of storage locations 121s of the storage section 121. That is, the association information Ir represents a storage structure in which the plurality of storage locations 121s are associated with each other so that the device data Idd and the storage section 121 correspond to each other. As described above, the storage section 121 is configured by the control section 110. The association information Ir is referred to by the control section 110 in order for the control section 110 to configure the storage section 121 in the memory section 120.

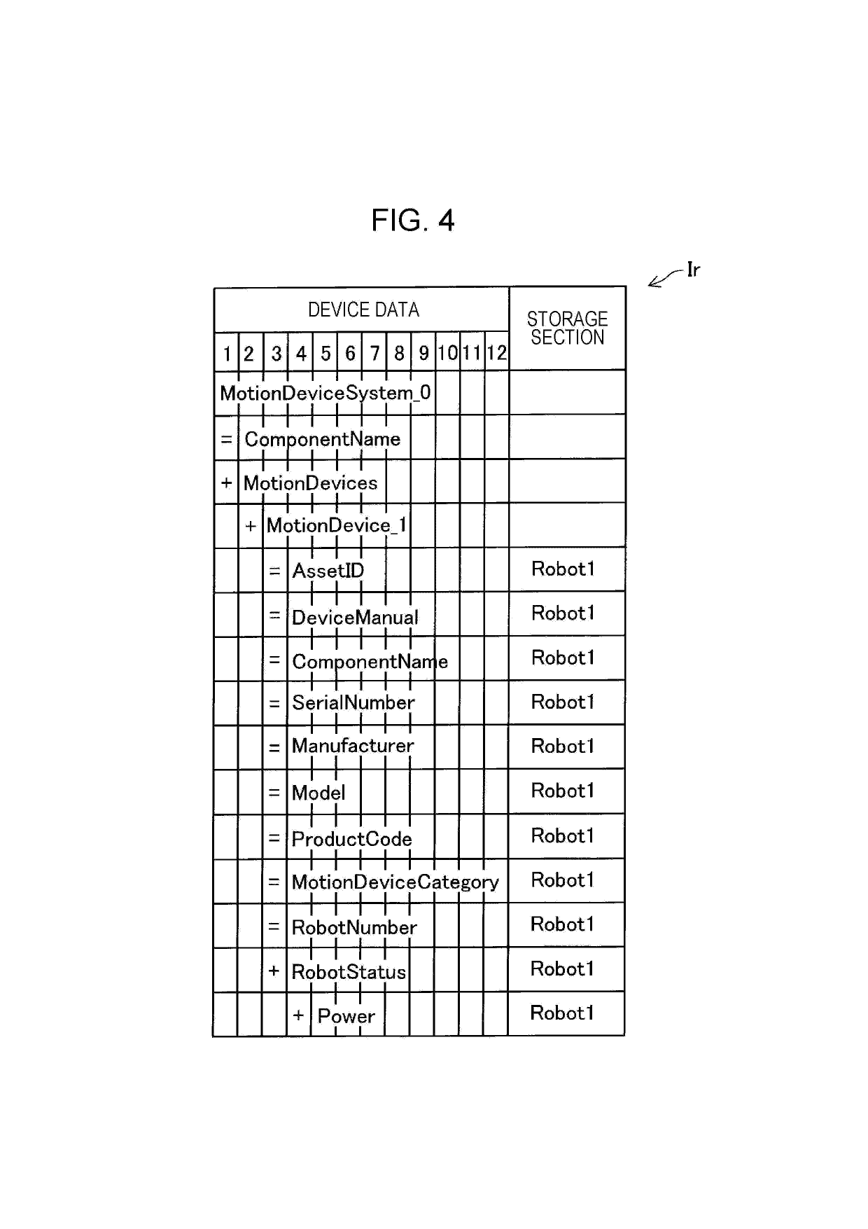

FIG. 4 is an explanatory diagram illustrating an example of the association information Ir. The example of the association information Ir of FIG. 4 represents the association between the plurality of sets of information Ids and the plurality of storage locations 121s by a table format. In the example of the association information Ir of FIG. 4, the device data Idd is based on the example of the data structure of FIG. 2, and the storage section 121 is based on the example of the storage structure of FIG. 4. In the example of the association information Ir of FIG. 4, the column of "device data" on the left represents the example of the data structure in FIG. 2. That is, the numbers at the top portion represent the number of hierarchies. A column including the initial character of the name of the storage destination represents the number of hierarchies of each storage destination. Further, in the example of the association information Ir in FIG. 4, the column of "storage section" on the right represents the example of the storage structure of FIG. 3.

The example of the association information Ir of FIG. 4 represents a plurality of storage locations 121s in which the plurality of sets of information Ids are to be stored in the row. More specifically, in the example of the association information Ir of FIG. 4, in each row, by arranging the information Id of each of the plurality of sets of information Ids and the storage location of each of the plurality of storage locations 121s, the storage location in which each information Id is to be stored is represented.

In the example of the association information Ir of FIG. 4, the storage structure is represented to the extent that the control section 110 can recognize the storage structure. Specifically, the example of the association information Ir of FIG. 4 represents the storage structure only by "Robot1" of the third hierarchy. That is, in the example of the association information Ir of FIG. 4, with respect to the storage structure, the names of the hierarchies higher than the third hierarchy are omitted.

Further, in the example of the association information Ir of FIG. 4, with respect to the storage structure, the hierarchies lower than the third hierarchy are omitted. This is because the association information Ir has the number of storage locations in which the plurality of sets of information Ids can be stored, and the storage structure corresponds to the data structure. That is, in the example of the association information Ir of FIG. 4, since the fourth hierarchy has the number of storage locations in which the plurality of sets of information Ids can be stored, a plurality of storage locations in which the plurality of sets of information Ids can be stored can be determined from the parent segment information of those storage locations.

However, the association information Ir represents the association between the plurality of sets of information Ids and the plurality of storage locations 121s for a part of the plurality of sets of information Ids. That is, the association information Ir does not associate the plurality of sets of information Ids with the plurality of storage locations 121s so as to store all the plurality of sets of information Ids in the storage section 121. For example, in the example of the association information Ir of FIG. 4, the plurality of sets of information Ids in the hierarchies lower than the third hierarchy of the device data Idd and the plurality of storage locations 121s are associated with each other. With such an aspect, the storage section 121 includes not all of the storage locations 121s of the plurality of sets of information Ids, but a part of the storage locations 121s. As a result, the storage structure of the storage section 121 is simplified. Therefore, the user can easily handle the plurality of sets of information Ids stored in the storage section 121.

The above-described "with each type of the device D for a part of the device D" will be described. The device D may be large in scale depending on the size of the factory. Therefore, the association information Ir is not created to correspond to all the devices D. In addition, the association information Ir is created by the manufacturer of the device D. Therefore, the association information Ir is created, for example, for each model of device D or each manufacturer of device D as "with each type of the device D for a part of the device D". The association information Ir is not limited to the manufacturer of the device D, and may be created by the manufacturer or the user of the data mapping system 10. Further, the association information Ir may be created for a part of the devices D for each classification of the device D or each division in which the device D is managed.

Further, regardless of the plurality of hierarchies of the device data Idd, in one hierarchy related to the type of the device D, the association information Ir associates the plurality of sets of information Ids with the plurality of storage locations 121s. For example, the association information Ir of FIG. 4 combines the plurality of hierarchies of the fourth hierarchy and a fifth hierarchy in the example of the data structure of FIG. 2 into one hierarchy of the fourth hierarchy in the example of the storage structure of FIG. 3. With such an aspect, the storage structure is simpler than the data structure. As a result, the user can easily handle the plurality of sets of information Ids stored in the storage section 121.

As described above, the data structure may be other than hierarchical. For example, when the data structure is the RDB type, the association information Ir may associate the plurality of sets of information Ids, a plurality of storage locations 121s represented to specify the table and the column.

### A-3. Data Mapping Method:

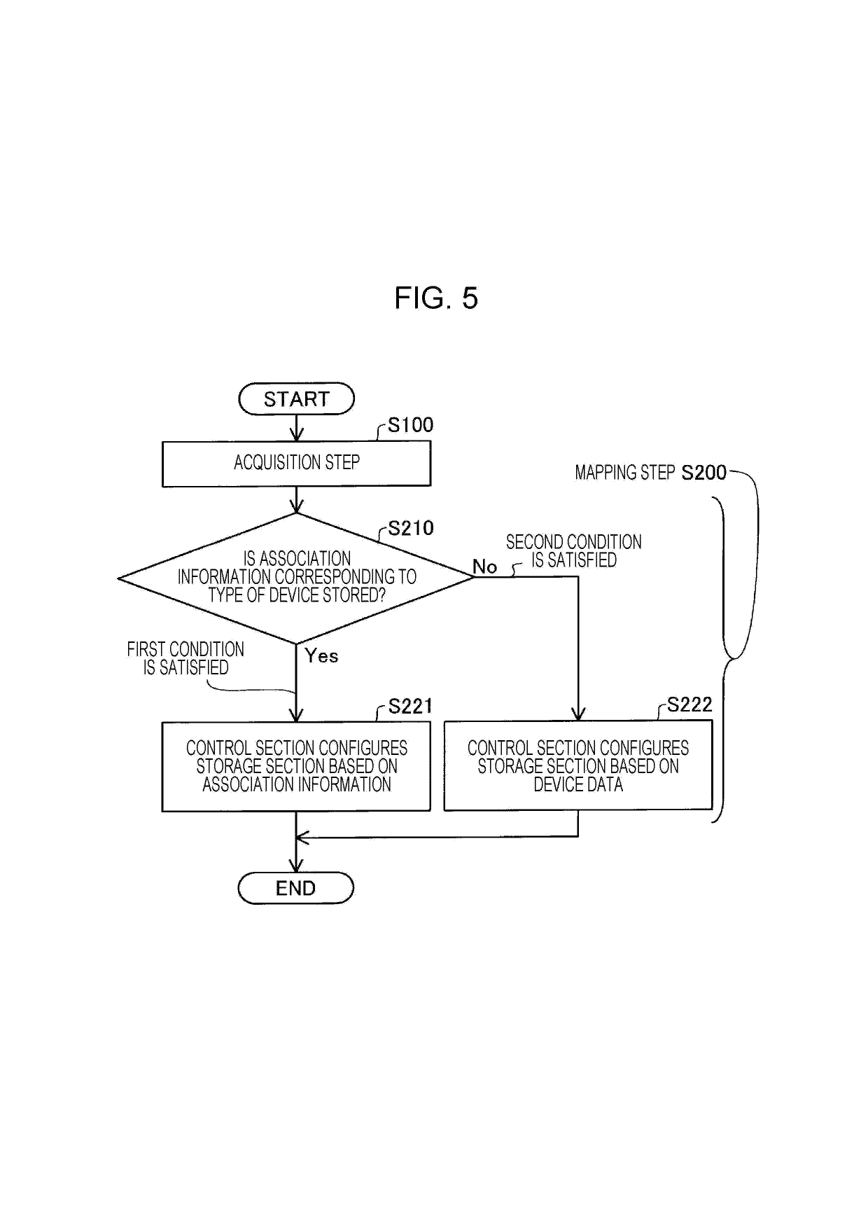

FIG. 5 is a flowchart illustrating the data mapping method. In the following, the data mapping method of determining the plurality of storage locations 121s for storing the plurality of sets of information Ids of the device data Idd in the data mapping system 10 will be described.

The control section 110 stores the association information Ir in the memory section 120 before the control section 110 performs the following processing. Further, the information aggregation section 300 stores the device data Idd by acquiring the plurality of sets of information Ids from the device D in advance.

The control section 110 starts the following process when the information aggregation section 300 and the management section 100 are connected. The "connection between the information aggregation section 300 and the management section 100" means that the management section 100 is in a state where the device data Idd can be acquired. With such an aspect, the data mapping method of the present embodiment can prevent the mapping from being omitted by reliably executing the mapping at the first stage when the device D and the management section 100 are connected.

In an acquisition step S100 of FIG. 5, the control section 110 acquires the device data Idd from the information aggregation section 300. That is, the control section 110 acquires the plurality of sets of information Ids and the data structure from the information aggregation section 300. As for the data structure, for example, when the control section 110 communicates with the information aggregation section 300 using the OPC UA, the control section 110 acquires the data structure based on the address space.

In a mapping step S200 of FIG. 5, the control section 110 configures the storage section 121 in the memory section 120. The mapping step S200 of FIG. 5 includes a determination step S210, a first execution step S221, and a second execution step S222.

In the determination step S210 of FIG. 5, the control section 110 determines whether or not a first condition or a second condition is satisfied.

The first condition is that the memory section 120 stores the association information Ir corresponding to the type of the device D represented by the type information Idt included in the acquired device data Idd. For example, when the association information Ir is created for each model of the device D, the first condition is that the association information Ir corresponding to the model represented by "Model" in the example of the data structure of FIG. 2 is stored in the memory section 120. When the first condition is satisfied (Yes in S210), the control section 110 can read the association information Ir corresponding to the type information Idt from the memory section 120. The control section 110, when the first condition is satisfied, proceeds with the processing to the first execution step S221.

The second condition is that the memory section 120 does not store the association information Ir corresponding to the type of the device D represented by the type information Idt included in the acquired device data Idd. That is, the second condition is a condition opposite to the first condition. For example, when the association information Ir is created for each model of the device D, the second condition is that the association information Ir corresponding to the model represented by "Model" in the example of the data structure of FIG. 2 is not stored in the memory section 120. When the second condition is satisfied (No in S210), the control section 110 cannot read the association information Ir corresponding to the type information Idt. The control section 110, when the second condition is satisfied, proceeds with the processing to the second execution step S222.

In the first execution step S221 of FIG. 5, the control section 110 configures the storage section 121 in the memory section 120 based on the association information Ir. More specifically, the control section 110 refers to the association information Ir based on the type information Idt included in the acquired device data Idd. Further, the control section 110 configures the storage section 121 including the plurality of storage locations 121s in the memory section 120 based on the referred association information Ir. As described above, in the association information Ir, the device data Idd and the storage section 121 are represented to correspond to each other. That is, the control section 110 configures the plurality of storage locations 121s in the memory section 120 in accordance with the storage structure in the association information Ir.

The control section 110 may configure the storage section 121 by ensuring a physical storage region in the memory section 120. Alternatively, the control section 110 may configure the storage section 121 by dynamically allocating the storage region. The same applies when the control section 110 configures the storage section 121 under other conditions.

In the second execution step S222 of FIG. 5, the control section 110 configures the storage section 121 including the plurality of storage locations 121s in the memory section 120 based on the data structure included in the acquired device data Idd. More specifically, the control section 110 configures the storage section 121 in the memory section 120 with the same structure as the data structure of the device data Idd. That is, the newly configured storage section 121 includes a storage structure with the same structure as the data structure of the device data Idd.

After configuring the storage section 121, the control section 110 ends the processing. As described above, the plurality of storage locations 121s for storing the plurality of sets of information Id of the device data Idd in the data mapping system 10 are determined.

In such an aspect, in the data mapping method of the present embodiment, when the first condition is satisfied, the storage section 121 including the plurality of storage locations 121s represented by the association information Ir is configured in the memory section 120. The data mapping method of the present embodiment has a high possibility of configuring the storage section 121 that is easy for the user to handle by using the association information Ir stored in the memory section 120. When the second condition is satisfied, the control section 110 cannot configure the storage section 121 based on the association information Ir. However, in the data mapping method of the present embodiment, the control section 110 configures the storage section 121 based on the data structure, so that the user does not need to perform the mapping work. Accordingly, the data mapping method of the present embodiment can reduce the burden of the user's mapping work.

As described above, the acquisition step S100 is executed when the information aggregation section 300 and the management section 100 are connected to each other. With such an aspect, the data mapping method of the present embodiment starts the processing up to the mapping step S200 when the information aggregation section 300 and the management section 100 are connected to each other. As a result, the data mapping method of the present embodiment ensures reliable execution of the mapping. More specifically, during the process in which another connection processing or another acquisition step is performed, for example, between the connection processing of the information aggregation section 300 and the management section 100 and execution of the acquisition step S100, there is a possibility that the processing proceeds without the mapping being performed. Therefore, in the data mapping method of the present embodiment, the mapping is reliably executed at the first stage when the information aggregation section 300 and the management section 100 are connected to each other, and thus the omission of the mapping can be prevented.

Further, the association information Ir represents the association between the plurality of sets of information Ids and the plurality of storage locations 121s for a part of the plurality of sets of information Ids. With such an aspect, the storage section 121 includes not all of the storage locations 121s of the plurality of sets of information Ids, but a part of the storage locations 121s. As a result, the storage structure of the storage section 121 is simplified. Therefore, the user can easily handle the plurality of sets of information Ids stored in the storage section 121.

Further, the association information Ir associates the plurality of sets of information Ids with the plurality of storage locations 121s in one hierarchy related to the type of the device D regardless of the plurality of hierarchies of the device data Idd. With such an aspect, the storage structure is simpler than the data structure. As a result, the user can easily handle the plurality of sets of information Ids stored in the storage section 121.

### B. Second Embodiment

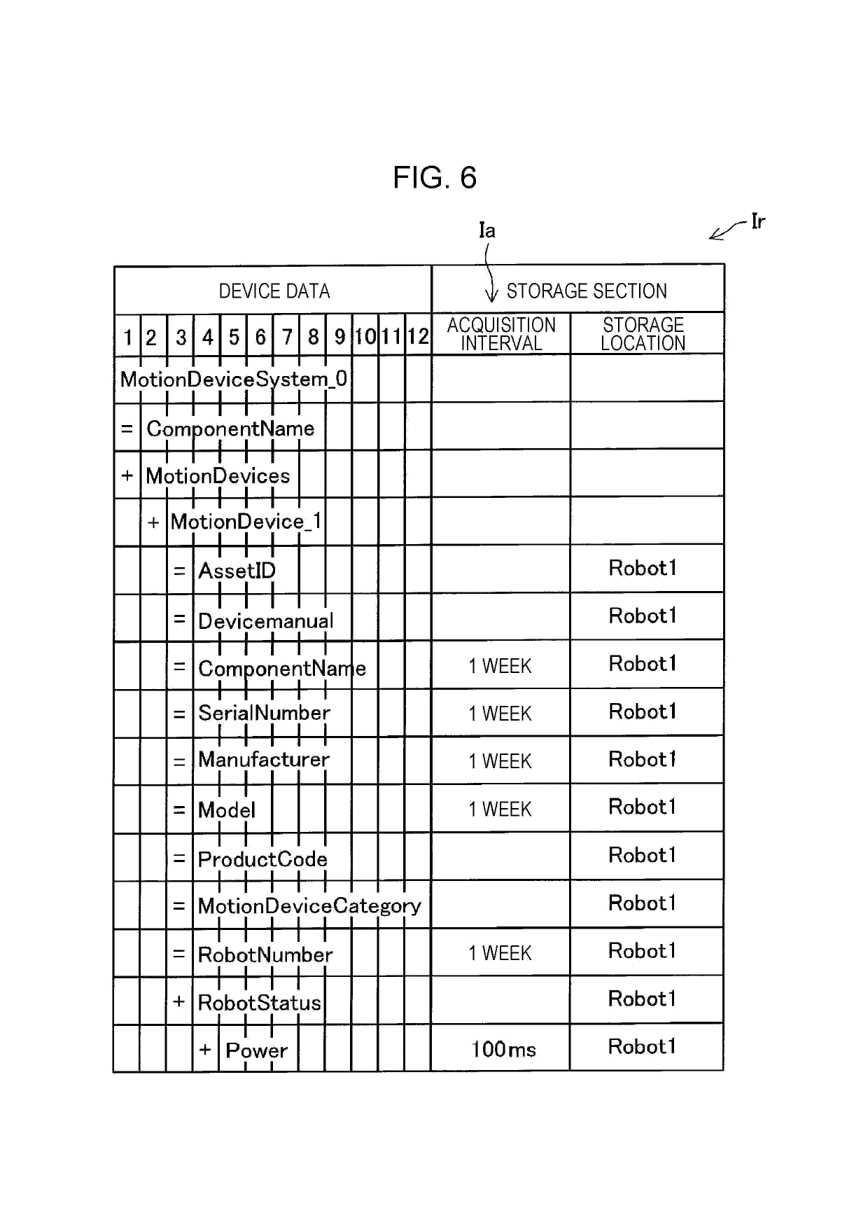

FIG. 6 is an explanatory diagram illustrating an example of acquisition interval information Ia in a second embodiment. In the above embodiment, the memory section 120 stores the association information Ir. In the second embodiment, the memory section 120 further stores the acquisition interval information Ia. The acquisition interval information Ia represents an interval at which the control section 110 acquires the plurality of sets of information Ids. That is, the acquisition interval information Ia represents a cycle in which the control section 110 acquires the information Id of each of the plurality of sets of information Ids from the information aggregation section 300. The acquisition interval information Ia is represented so as to correspond to the device data Idd and the storage section 121. In the example of the acquisition interval information Ia of FIG. 6, the acquisition interval information Ia is added between the column of "storage location" and the column of "device data" in the example of the association information Ir of FIG. 4. That is, in the example of the acquisition interval information Ia of FIG. 6, the acquisition interval information Ia is represented so as to correspond to the device data Idd and the storage section 121 by being arranged together with the information Id of each of the plurality of sets of information Ids and the storage location of each of the plurality of storage locations 121s in each row.

The acquisition interval may not be set for all the plurality of sets of information Ids as in the example of the acquisition interval information Ia of FIG. 6. When the acquisition interval is not set, the control section 110, for example, acquires only once, or acquires upon a command from the user when the data mapping system 10 is provided with an operation section.

Other configurations of the data mapping system 10 of the second embodiment are the same as the configurations of the data mapping system 10 of the first embodiment. In the following, the data mapping method of the second embodiment will be described. The data mapping method of the second embodiment described below is also referred to as a "data storing method".

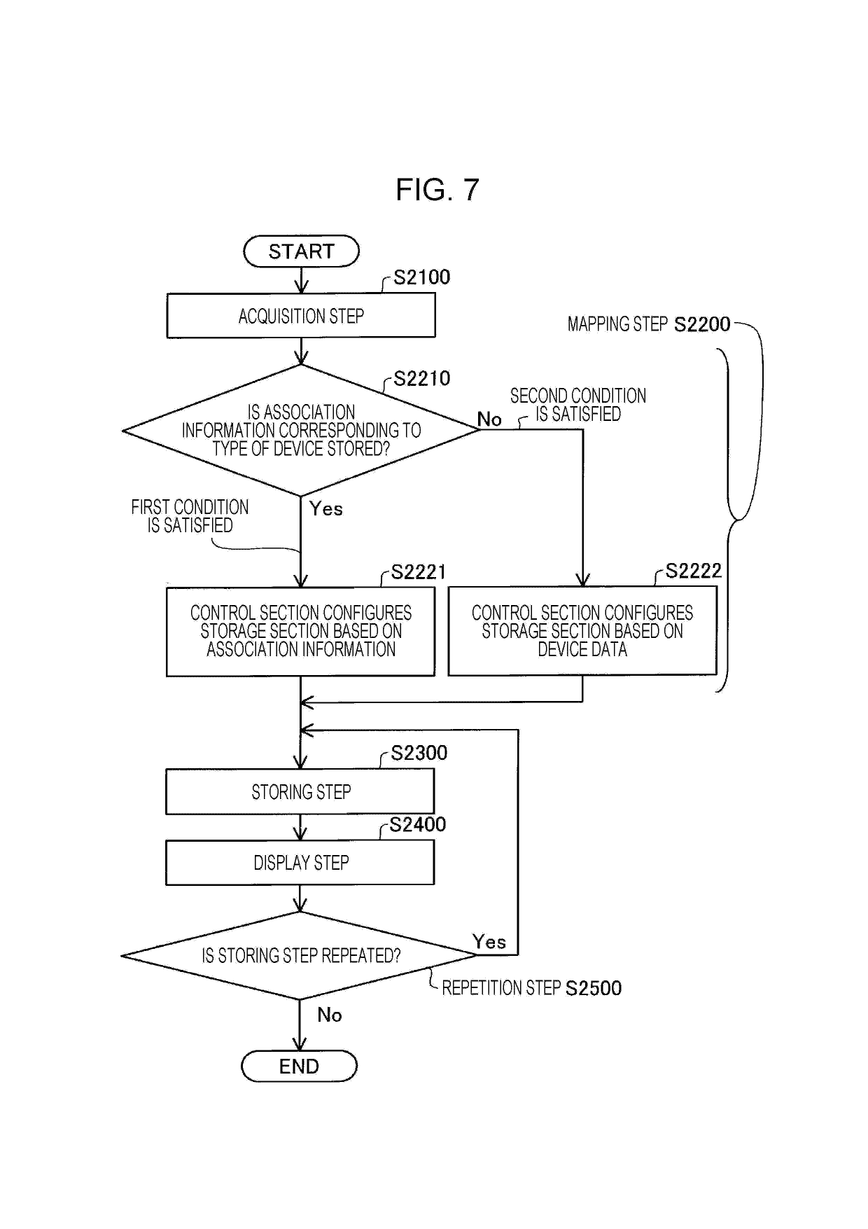

FIG. 7 is a flowchart illustrating the data mapping method of the second embodiment. An acquisition step S2100 and a mapping step S2200 of FIG. 7 are the same as the acquisition step S100 and the mapping step S200 of FIG. 5.

In a storing step S2300 of FIG. 7, the control section 110 acquires the device data Idd from the information aggregation section 300. Further, the control section 110 stores the plurality of sets of information Ids in the storage section 121. That is, the control section 110 starts collecting the plurality of sets of information Ids.

In a display step S2400 of FIG. 7, the control section 110 displays a result of the storing step S2300 on the display section 200. That is, the control section 110 displays the plurality of sets of information Ids stored in the storage section 121 on the display section 200.

In a repetition step S2500 of FIG. 7, the control section 110 determines whether or not to repeat the storing step S2300. More specifically, when the storing step S2300 is to be repeated (Yes in S2500), the control section 110 returns the processing to the storing step S2300 at an interval based on the acquisition interval information Ia when the acquisition interval information Ia is included. That is, the control section 110 repeats the storing step S2300 and the display step S2400 at an interval based on the acquisition interval information Ia. More specifically, the control section 110 repeats the storing step S2300 and the display step S2400 for the information Id of each of the plurality of sets of information Ids at an interval based on the acquisition interval information Ia. When the storing step S2300 is not to be repeated (No in S2500), the control section 110 ends the processing when not having the acquisition interval information Ia.

The display step S2400 may not necessarily be performed every time the storing step S2300 ends. For example, since the data mapping system 10 includes the operation section, the control section 110 may display a result of the latest storing step S2300 on the display section 200 in response to the user's request.

With such an aspect, the data mapping method of the present embodiment can efficiently store the plurality of sets of information Ids as compared with the aspect in which the acquisition interval is a fixed value. That is, the data mapping method of the present embodiment can store the information of each of the plurality of sets of information Ids at the acquisition interval suitable for each information. For example, the user stores the acquisition interval information Ia in which the acquisition interval of the information Id updated at a high frequency is short or the acquisition interval of the information Id updated at a low frequency is long, in the memory section 120. Accordingly, since the possibility that the control section 110 acquires information that has not been updated is reduced, the data mapping method of the present embodiment can prevent the waste of the control section 110 repeatedly acquiring the same information and prevent omission of acquisition of information.

### C. Third Embodiment

The device data Idd may include specific information Idi for specifying the device D. The specific information Idi is, for example, an identification number that can identify a device D of the same type. In the example of the data structure of FIG. 2, the identification number is, for example, "AssetID". The specific information Idi may be a manufacturing number, a manufacturing year, a lot number, and the like.

Other configurations of the data mapping system 10 of the third embodiment are the same as the configurations of the data mapping system 10 of the first embodiment.

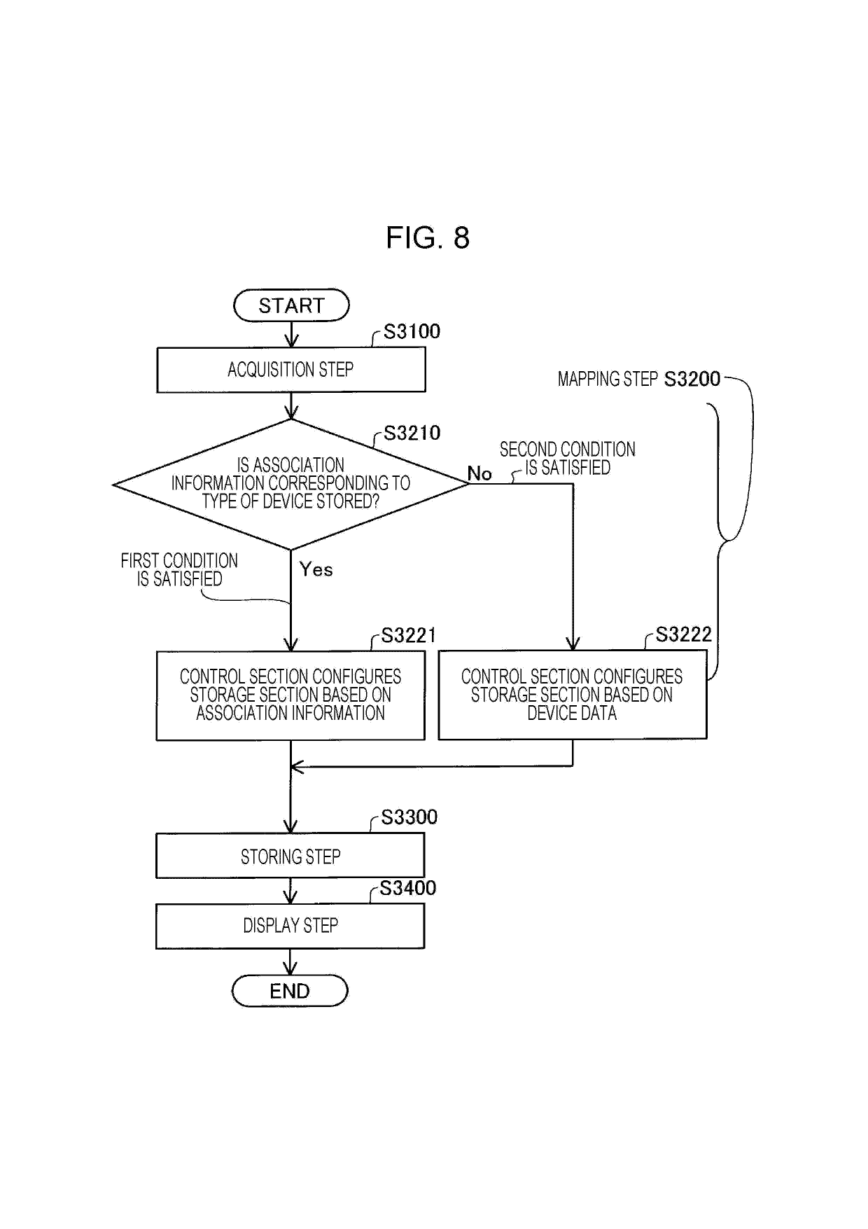

FIG. 8 is a flowchart illustrating a data mapping method of the third embodiment. In an acquisition step S3100 of FIG. 8, the control section 110 acquires the plurality of sets of information Ids, the data structure, and the specific information Idi from the information aggregation section 300.

A mapping step S3200 and a storing step S3300 of FIG. 8 are the same as the mapping step S2200 and the storing step S2300 of FIG. 7.

In a display step S3400 of FIG. 8, the control section 110 displays the information related to the storage section 121 on the display section 200 together with the specific information Idi. For example, the control section 110 displays the plurality of sets of information Ids stored in a state in which identification numbers are added. As described above, the control section 110 ends the processing.

With such an aspect, even when a plurality of devices D of the same type exist, it becomes easy for the user to specify the device D based on the specific information Idi.

### D. Fourth Embodiment:

In the mapping step in the above embodiment, determination conditions of the first condition and the second condition are used. However, in a mapping step S4200 of the fourth embodiment, a third condition is further used as the determination condition.

In order to determine the third condition, in the fourth embodiment, the storage structure is a data type that is predetermined. More specifically, the storage structure is predetermined to be any of a hierarchical type, a network type, and a Relational DataBase (RDB) type.

Further, in order to determine the third condition, in the fourth embodiment, the second condition of the fourth embodiment includes that the type of the data in the storage structure and the type of the data in the data structure are the same. That is, the second condition of the fourth embodiment includes the following two conditions. The first of the second conditions is that the memory section 120 does not store the association information Ir corresponding to the type of the device D represented by the type information Idt included in the acquired device data Idd. The second of the second conditions is that the type of the data in the storage structure and the type of the data in the data structure are the same as described above.

The third condition includes the following two conditions. The first of the third conditions is that the memory section 120 does not store the association information Ir corresponding to the type of the device D represented by the type information Idt included in the acquired device data Idd. The first of the third conditions is the same as the first of the second conditions. Further, the second of the third conditions is that a data type in the storage structure is different from a data type in the data structure. That is, when the first condition and the second condition are not satisfied, the third condition is satisfied. The second of the third conditions is satisfied, for example, when the storage structure is the hierarchical type and the data structure is the RDB type or the network type.

Other configurations of the data mapping system 10 of the fourth embodiment are the same as the configurations of the data mapping system 10 of the first embodiment. In the data mapping method of the fourth embodiment, points not specifically mentioned are the same as those in the data mapping method of the first embodiment. In the following, the data mapping method of the fourth embodiment will be described.

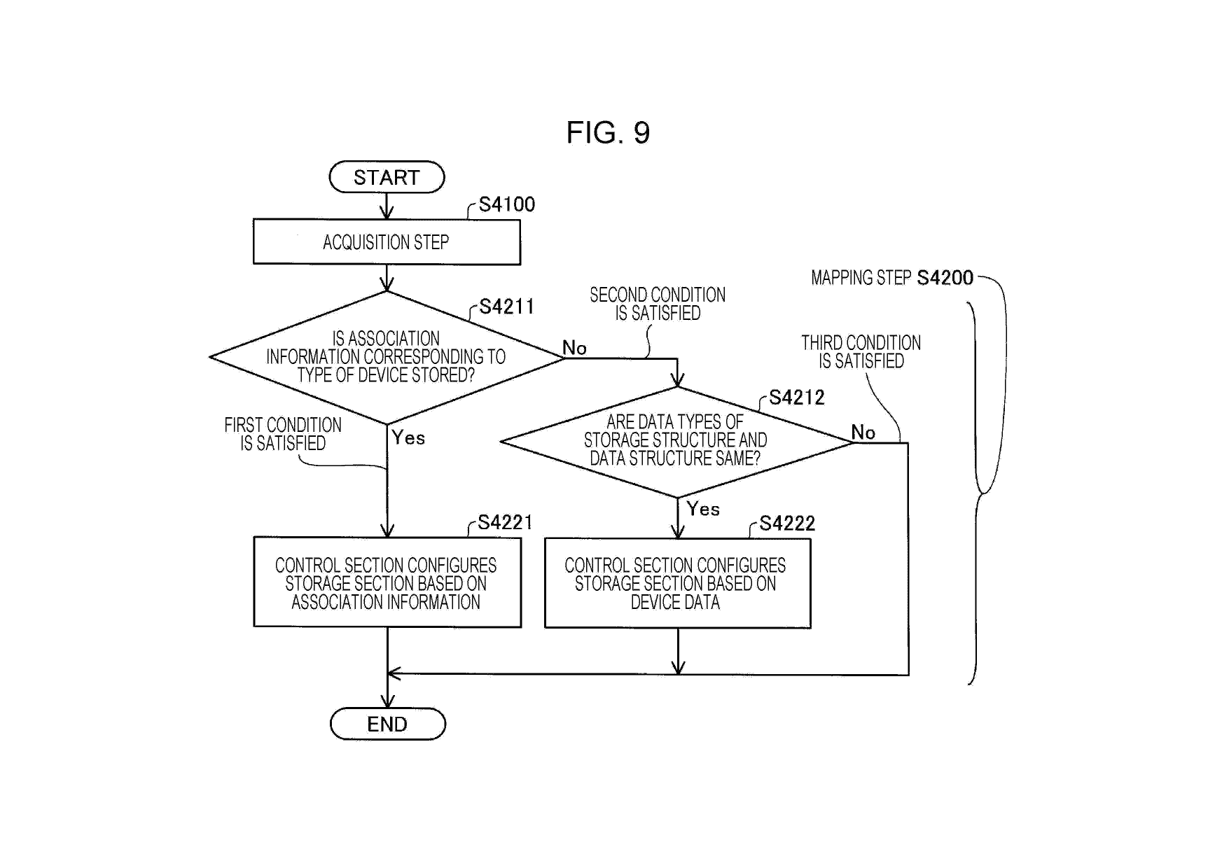

FIG. 9 is a flowchart illustrating the data mapping method of the fourth embodiment. An acquisition step S4100 of FIG. 9 is the same as the acquisition step S100 of FIG. 5.

In a mapping step S4200 of FIG. 9, the control section 110 configures the storage section 121 in the memory section 120. The mapping step S4200 of FIG. 9 includes a first determination step S4211, a second determination step S4212, a first execution step S4221, and a second execution step S4222.

In the first determination step S4211 of FIG. 9, the control section 110 determines whether or not the first condition is satisfied. The first condition is that the memory section 120 stores the association information Ir corresponding to the type of the device D represented by the type information Idt included in the acquired device data Idd. When the first condition is satisfied (Yes in S4211), the control section 110 proceeds with the processing to the first execution step S4221.

The first execution step S4221 of FIG. 9 is the same as the first execution step S221 of FIG. 5. On the other hand, when the first condition is not satisfied (No in S4211), the control section 110 proceeds with the processing to the second determination step S4212.

In the second determination step S4212 of FIG. 9, the control section 110 determines whether or not the second condition is satisfied. More specifically, since the first of the second conditions is satisfied when the first condition is not satisfied, in the second determination step S4212, it is determined whether or not the second of the second conditions is satisfied. When the second of the second conditions is satisfied in the second determination step S4212 (Yes in S4212), the control section 110 proceeds with the processing to the second execution step S4222 assuming that the second condition is satisfied.

In the second determination step S4212, when the second of the second conditions is not satisfied, the third condition is satisfied. When the third condition is satisfied (No in S4212), the control section 110 ends the processing. That is, the control section 110 does not configure the storage section 121 including the plurality of storage locations 121s in the memory section 120. The control section 110 may notify the user that the storage section 121 is not configured by displaying a result of the second determination step S4212 on the display section 200.

The second execution step S4222 of FIG. 9 is the same as the second execution step S222 of FIG. 5.

With such an aspect, the data mapping method of the present embodiment can prevent the control section 110 from being unable to perform processing when the control section 110 cannot configure the storage section 121 in the memory section 120 based on the data structure. That is, the data mapping method of the present embodiment can prevent the control section 110 from freezing and hanging up.

### E. Fifth Embodiment:

In a fifth embodiment, the storage structure is hierarchical. Further, in the fifth embodiment, the device data Idd includes a plurality of information sets in which a part of the plurality of sets of information Ids is combined. For example, when the data structure is of the RDB type, the information set is the same set of information belonging to the column of the table.

Other configurations of the data mapping system 10 of the fifth embodiment are the same as the configurations of the data mapping system 10 of the first embodiment. In the following, the data mapping method of the fifth embodiment will be described. In the data mapping method of the fifth embodiment, points not specifically mentioned are the same as those in the data mapping method of the fourth embodiment.

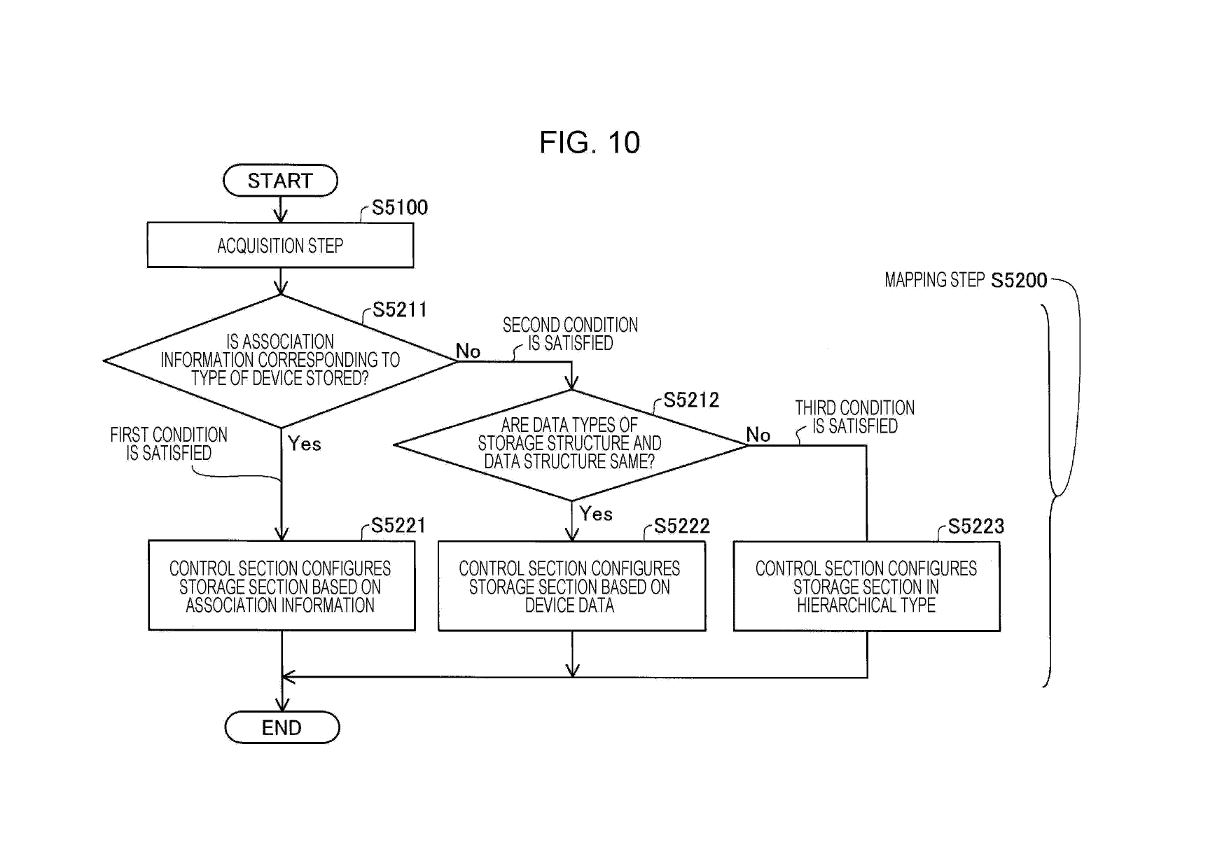

FIG. 10 is a flowchart illustrating the data mapping method of the fifth embodiment. An acquisition step S5100 of FIG. 10 is the same as the acquisition step S100 of FIG. 5.

In a mapping step S5200 of FIG. 10, the control section 110 configures the storage section 121 in the memory section 120. The mapping step S5200 of FIG. 10 includes a first determination step S5211, a second determination step S5212, a first execution step S5221, a second execution step S5222, and a third execution step S5223. The first determination step S5211 and the first execution step S5221 in FIG. 10 are the same as the first determination step S4211 and the first execution step S4221 of FIG. 9.

In the second determination step S5212 of FIG. 10, the control section 110 determines whether or not the third condition is satisfied. When the third condition is not satisfied (Yes in S5212), the control section 110 proceeds with the processing to the second execution step S5222. The second execution step S5222 of FIG. 10 is the same as the second execution step S4222 of FIG. 9. When the third condition is satisfied (No in S5212), the control section 110 causes the processing to proceed to the third execution step S5223.

In the third execution step S5223 of FIG. 10, the control section 110 hierarchically configures the storage section 121 including the plurality of storage locations 121s in the memory section 120 on the assumption that the third condition is satisfied. More specifically, the control section 110 configures the storage section 121 including the plurality of storage locations 121s as the parent segments for each of the plurality of information sets and the child segments for each part of the plurality of sets of information Ids. For example, when the data structure is of the RDB type, the control section 110 determines a plurality of information sets by determining, as one information set, the same set of information belonging to the column of the table. The control section 110 determines each information set as a parent segment. The control section 110 determines each information included in each information set as a child segment of the determined parent segment. That is, the control section 110 configures the storage section 121 so as to make the device data Idd of the RDB type hierarchical.

In such an aspect, regardless of the data type in the data structure, since the storage structure is unified in a hierarchical type, the user can handle the storage section 121 more easily rather than the storage structure being configured in various structures. Further, in the data mapping method of the present embodiment, when the data structure is not hierarchical, the control section 110 cannot configure the storage section 121, and thus the control section 110 can be prevented from being unable to perform processing.

### F. Sixth Embodiment:

In the above embodiment, the storage section 121 may further include a plurality of assets, each of which includes a plurality of properties as a plurality of storage locations 121s. That is, the asset is a parent segment in the hierarchical type. For example, in FIG. 4 of the first embodiment, the property is each segment of the fourth hierarchy. Further, the asset is, for example, "Robot1" in the third hierarchy.

Furthermore, when the association information Ir of the first embodiment is created using properties and assets, the association information Ir makes the storage structure correspond to the data structure so as to have a plurality of properties in a number capable of storing the plurality of sets of information Ids. Further, the association information Ir associates any of the plurality of assets with the plurality of sets of information Ids.

In such an aspect, the association information Ir does not associate each of the plurality of sets of information Ids with a different property. More specifically, since the data structure and the storage structure are associated with each other in the association information Ir, when any of the plurality of assets is associated with the plurality of sets of information Ids, the plurality of sets of information Ids are associated with the plurality of properties included in the asset. Therefore, the association information Ir is easily created as compared with the aspect in which each of the plurality of sets of information Ids is associated with a different property.

### G. Seventh Embodiment:

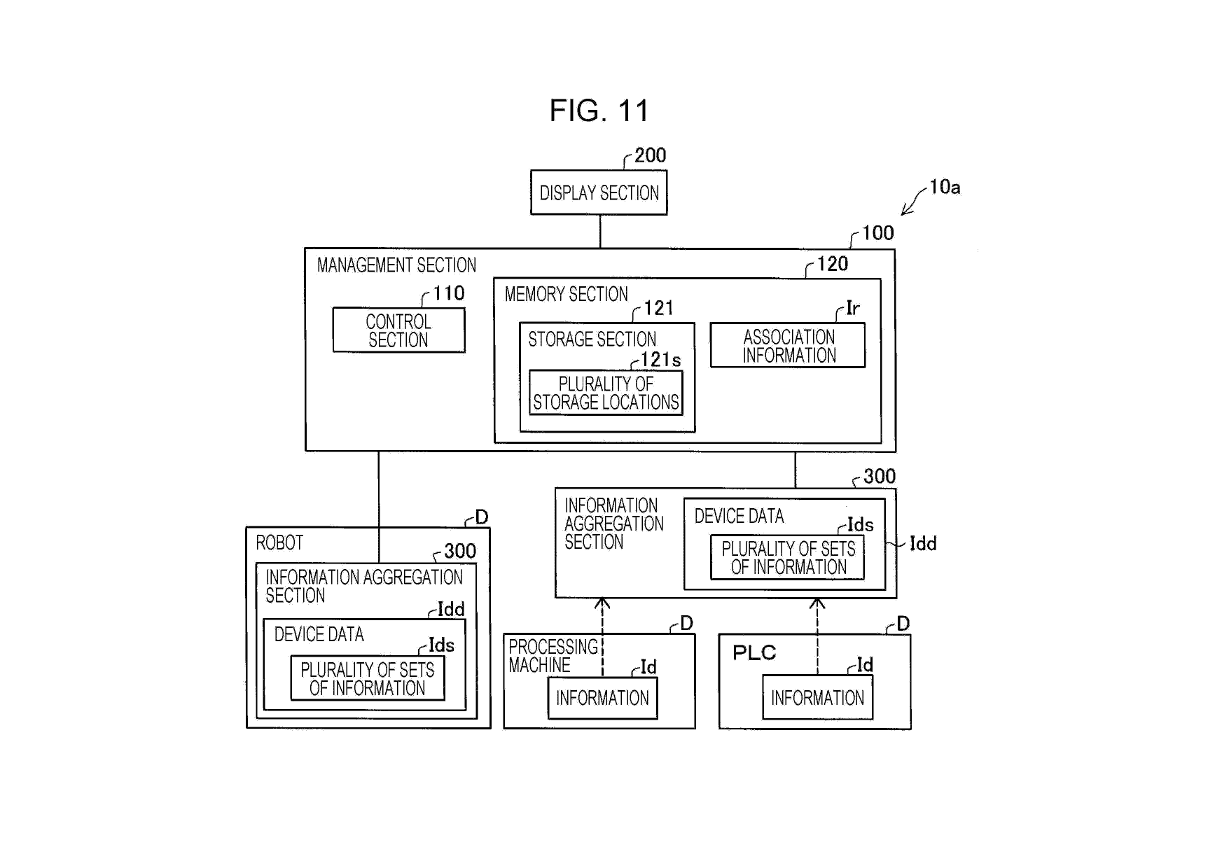

FIG. 11 is an explanatory diagram illustrating a data mapping system 10a of a seventh embodiment. In the above embodiment, the information aggregation section 300 acquires the plurality of sets of information Ids from the plurality of types of devices D as illustrated in FIG. 1. However, the information aggregation section 300 may be provided for each type of the device D or each individual device. For example, as illustrated in FIG. 11, the data mapping system 10a may include two information aggregation sections 300. For example, in the data mapping system 10a, among two information aggregation sections 300, one information aggregation section may be included in a robot, and the other information aggregation section may be connected to a processing machine and a PLC.

### H. Other Embodiments:

H1. In the above embodiment, the device D is equipment used in a factory. However, the device D is not limited to the equipment used in the factory. For example, the device D may be equipment used in a facility other than the factory, a building, or the like. For example, the device D may be a printer used in the facility other than the factory, or may be a vibration meter installed in a building.

H2. In the above embodiment, the device D may be configured by a plurality of robots. More specifically, the data mapping system 10 of the above embodiment may be configured as a robot monitoring system. When the robot monitoring system is realized, for example, the robot monitoring system collects the information Id from the plurality of robots as the device D. Further, the plurality of sets of information Ids of the plurality of robots are sequentially stored in the storage section 121 configured by the data mapping method. Then, by visualizing the plurality of sets of information Ids accumulated in the storage section 121, a robot monitoring system may be configured in which the user can monitor states of the plurality of operating robots. In this case, a configuration may be adopted in which a screen generated based on the plurality of sets of information Ids stored in the storage section 121 is displayed on the display section 200.

H3. In the above embodiment, the OPC UA is used for the communication of the device data Idd, but other technologies may be used. For example, Message Queuing Telemetry Transport (MQTT) may be used for the communication of the device data Idd. When the MQTT is used, for example, the device data Idd is represented in a hierarchical type in the data structure by a topic hierarchy.

H4. In the above embodiment, the association information Ir represents the association between the plurality of sets of information Ids and the plurality of storage locations 121s for a part of the plurality of sets of information Ids. However, the association information Ir may represent the association between the plurality of sets of information Ids and the plurality of storage locations 121s for all of the plurality of sets of information Ids.

H5. In the above-described embodiment, the association information Ir associates the plurality of sets of information Ids with the plurality of storage locations 121s in one hierarchy related to the type of the device D regardless of the plurality of hierarchies of the device data Idd. However, the association information Ir may perform the association between the plurality of sets of information Ids and the plurality of storage locations 121s in a plurality of hierarchies related to the type of the device D.

H6. In the above embodiment, the control section 110 starts the processing according to the data mapping method when the information aggregation section 300 and the management section 100 are connected. However, the control section 110 may start the processing according to the data mapping method regardless of the connection between the information aggregation section 300 and the management section 100. For example, the control section 110 may start the processing according to the data mapping method after receiving an instruction to execute the data mapping method from the user, by the management section 100 being provided with the operation section.

H7. In the above embodiment, when the second condition is satisfied, the control section 110 configures the storage section 121 in the memory section 120 with the same structure as the data structure. However, the control section 110 may configure the storage section 121 including the plurality of storage locations 121s in the memory section 120 based on the data structure included in the acquired device data Idd. For this reason, for example, the control section 110 may configure the storage section 121 in the memory section 120 with a structure partially identical to the data structure. For example, the control section 110 may configure the storage section 121 in the memory section 120 with the same structure as a lower hierarchy than a specific hierarchy in the data structure.

H8. In the above embodiment, the memory section 120 may store unit information, numerical value type information, and the like in addition to the acquisition interval information Ia. For example, when the storage section 121 is configured, the control section 110 may use the unit information or the numerical value type information stored in the memory section 120 when the unit information or the numerical value type information is required as the storage location setting.

H9. In the seventh embodiment, the storage section 121 includes a plurality of assets. However, the storage section 121 may include only one asset. Further, the asset may be in a mode including only one property.

### I. Other Aspects:

The present disclosure is not limited to the above embodiments, and may be realized in various configurations without departing from the concept thereof. For example, the technical features of the embodiments corresponding to technical features in respective aspects described in SUMMARY of the present disclosure can be replaced or combined as appropriate in order to solve some or all of the above-described problems or to achieve some or all of the above-described effects. In addition, when the technical features are not described as essential in the present specification, the technical features can be appropriately deleted.

I1. According to a first aspect of the present disclosure, there is provided a data mapping method of determining a plurality of storage locations for respectively storing a plurality of sets of information of device data in a data mapping system. In the data mapping method, the device data includes the plurality of sets of information related to a device and has a data structure configured to associate the plurality of sets of information with each other, the plurality of sets of information includes type information representing a type of the device, the data mapping method includes an acquisition step of acquiring the device data, by a control section included in the data mapping system, and a mapping step of configuring a storage section including the plurality of storage locations, the storage section having a storage structure configured to associate the plurality of storage locations with each other and storing the plurality of sets of information, in a memory section included in the data mapping system, by the control section, the mapping step includes, when a first condition is satisfied, configuring the storage section in the memory section based on, among association information associating the plurality of sets of information with the plurality of storage locations for each type of the device with respect to a part of the device, the association information corresponding to the type of the device represented by the type information included in the acquired device data, and when a second condition is satisfied, configuring the storage section in the memory section based on the data structure included in the acquired device data, the first condition includes that the memory section stores the association information corresponding to the type of the device represented by the type information included in the acquired device data, and the second condition includes that the memory section does not store the association information corresponding to the type of the device represented by the type information included in the acquired device data.

In such an aspect, in the data mapping method when the first condition is satisfied, the storage section including the plurality of storage locations represented by the association information is configured in the memory section. The data mapping method has a high possibility of configuring the storage section that is easy for the user to handle by using the association information stored in the memory section. When the second condition is satisfied, the control section cannot configure the storage section based on the association information. However, in the data mapping method, the control section configures the storage section based on the data structure, so that the user does not need to perform the mapping work. Accordingly, the data mapping method can reduce the burden of the user's mapping work.

I2. In the above aspect, the acquisition step may be executed upon a connection between an information aggregation section configured to generate the device data by acquiring the plurality of sets of information from the device in advance, and a management section including the control section and the memory section, the information aggregation section and the management section being included in the data mapping system.

With such an aspect, the data mapping method starts the processing up to the mapping step when the information aggregation section and the management section are connected to each other. As a result, the data mapping method ensures reliable execution of the mapping. Therefore, in the data mapping method, the mapping is reliably executed at the first stage when the information aggregation section and the management section are connected to each other, and thus the mapping can be prevented from being omitted.

I3. In the above aspect, the storage section may further include a plurality of assets each including a plurality of properties as the plurality of storage locations, and the association information may make the data structure correspond to the storage structure so as to have the plurality of properties in a number capable of storing the plurality of sets of information, and associate any of the plurality of assets with the plurality of sets of information.

In such an aspect, the association information does not associate each of the plurality of sets of information with a different property. More specifically, since the data structure and the storage structure are associated with each other in the association information, when any of the plurality of assets is associated with the plurality of sets of information, the plurality of sets of information are associated with the plurality of properties included in the asset. Therefore, the association information is easily created as compared with the aspect in which each of the plurality of sets of information is associated with a different property.

I4. In the above aspect, the memory section may further store acquisition interval information, the acquisition interval information may be an interval at which the control section acquires the plurality of sets of information, and the data mapping method may further include, after the mapping step: a storing step of acquiring the device data and storing the plurality of sets of information in the storage section, by the control section; a display step of displaying a result of the storing step on a display section included in the data mapping system, by the control section; and a repetition step of repeatedly executing the storing step and the display step at an interval based on the acquisition interval information.

With such an aspect, the data mapping method can efficiently store the plurality of sets of information as compared with the aspect in which the acquisition interval is a fixed value.

I5. In the above aspect, the device data may include specific information for specifying the device, and the data mapping method may further include: after the mapping step, a storing step of acquiring the device data and storing the plurality of sets of information in the storage section, by the control section; and a display step of displaying the information related to the storage section on a display section included in the data mapping system together with the specific information, by the control section.

With such an aspect, even when a plurality of devices of the same type exist, it becomes easy for the user to specify the device based on the specific information. Therefore, the user can efficiently manage the device.

I6. In the above aspect, the storage structure may be of a predetermined data type, the second condition may further include that the data type in the storage structure is the same as a data type in the data structure, the mapping step may include, when the second condition is satisfied, configuring the storage section in the memory section with the same structure as the data structure, and further, when a third condition is satisfied, not configuring the storage section including the plurality of storage locations, in the memory section, and the third condition may include that the memory section does not store the association information corresponding to the type of the device represented by the type information included in the acquired device data, and that the data type in the storage structure is different from the data type in the data structure.

With such an aspect, the data mapping method can prevent the processing of the control section from being stopped when the control section cannot configure the storage section in the memory section based on the data structure.

I7. In the above aspect, the storage structure may be hierarchical, the device data may include a plurality of information sets in which a part of the plurality of sets of information is combined, the second condition may further include that a data type in the storage structure is the same as a data type in the data structure, the mapping step may include, when the second condition is satisfied, configuring the storage section in the memory section with the same structure as the data structure, and further, when a third condition is satisfied, configuring the storage section in the memory section in a hierarchical type with each of the plurality of information sets as a parent segment and each part of the plurality of sets of information as a child segment, and the third condition may include that the memory section does not store the association information corresponding to the type of the device represented by the type information included in the acquired device data and that the data type in the storage structure is different from the data type in the data structure.

In such an aspect, regardless of the data type in the data structure, since the storage structure is unified in a hierarchical type, the user can handle the storage section more easily rather than the storage structure being configured in various structures.

I8. In the above aspect, the association information may represent association between the plurality of sets of information and the plurality of storage locations for a part of the plurality of sets of information.

With such an aspect, the storage section includes not all of the storage locations of the plurality of sets of information, but a part of the storage locations. As a result, the storage structure of the storage section is simplified. Therefore, the user can easily handle the plurality of sets of information stored in the storage section.

I9. In the above aspect, the storage structure and the data structure may be hierarchical, the data structure may include a plurality of hierarchies, and the association information may make the storage structure correspond to the data structure so as to have storage locations in a number capable of storing the plurality of sets of information, and regardless of the plurality of hierarchies, in one hierarchy related to the type of the device, associate the plurality of sets of information with the plurality of storage locations.

With such an aspect, the storage structure is simpler than the data structure. As a result, the user can easily handle the plurality of sets of information stored in the storage section.

The present disclosure can be realized in various aspects other than the data mapping method. For example, it can be realized in the form of the data mapping system, the robot monitoring system, or the like.

1. A data mapping method of determining a plurality of storage locations for respectively storing a plurality of sets of information of device data in a data mapping system, wherein
the device data includes the plurality of sets of information related to a device and has a data structure configured to associate the plurality of sets of information with each other,
the plurality of sets of information includes type information representing a type of the device,
the data mapping method comprises:
an acquisition step of acquiring the device data, by a control section included in the data mapping system; and
a mapping step of configuring a storage section including the plurality of storage locations, the storage section having a storage structure configured to associate the plurality of storage locations with each other and storing the plurality of sets of information, in a memory section included in the data mapping system, by the control section,
the mapping step includes
when a first condition is satisfied, configuring the storage section in the memory section based on, among association information associating the plurality of sets of information with the plurality of storage locations for each type of the device with respect to a part of the device, the association information corresponding to the type of the device represented by the type information included in the acquired device data, and
when a second condition is satisfied, configuring the storage section in the memory section based on the data structure included in the acquired device data,
the first condition includes that the memory section stores the association information corresponding to the type of the device represented by the type information included in the acquired device data, and
the second condition includes that the memory section does not store the association information corresponding to the type of the device represented by the type information included in the acquired device data.

2. The data mapping method according to claim 1, wherein
the acquisition step is executed upon a connection between an information aggregation section configured to generate the device data by acquiring the plurality of sets of information from the device in advance, and a management section including the control section and the memory section, the information aggregation section and the management section being included in the data mapping system.

3. The data mapping method according to claim 1, wherein
the storage section further includes a plurality of assets each including a plurality of properties as the plurality of storage locations, and
the association information makes the data structure correspond to the storage structure so as to have the plurality of properties in a number capable of storing the plurality of sets of information, and associates any of the plurality of assets with the plurality of sets of information.

4. The data mapping method according to claim 1, wherein
the memory section further stores acquisition interval information,
the acquisition interval information is an interval at which the control section acquires the plurality of sets of information, and
the data mapping method further comprises, after the mapping step:
a storing step of acquiring the device data and storing the plurality of sets of information in the storage section, by the control section;
a display step of displaying a result of the storing step on a display section included in the data mapping system, by the control section; and
a repetition step of repeatedly executing the storing step and the display step at an interval based on the acquisition interval information.

5. The data mapping method according to claim 1, wherein
the device data includes specific information for specifying the device, and
the data mapping method further comprises, after the mapping step:
a storing step of acquiring the device data and storing the plurality of sets of information in the storage section, by the control section; and
a display step of displaying the information related to the storage section on a display section included in the data mapping system together with the specific information, by the control section.

6. The data mapping method according to claim 1, wherein
the storage structure is of a predetermined data type,
the second condition further includes that the data type in the storage structure is the same as a data type in the data structure,
the mapping step includes
when the second condition is satisfied, configuring the storage section in the memory section with the same structure as the data structure, and
further, when a third condition is satisfied, not configuring the storage section including the plurality of storage locations, in the memory section, and
the third condition includes that the memory section does not store the association information corresponding to the type of the device represented by the type information included in the acquired device data, and that the data type in the storage structure is different from the data type in the data structure.

7. The data mapping method according to claim 1, wherein
the storage structure is hierarchical,
the device data includes a plurality of information sets in which a part of the plurality of sets of information is combined,
the second condition further includes that a data type in the storage structure is the same as a data type in the data structure,
the mapping step includes
when the second condition is satisfied, configuring the storage section in the memory section with the same structure as the data structure, and
further, when a third condition is satisfied, configuring the storage section in the memory section in a hierarchical type with each of the plurality of information sets as a parent segment and each part of the plurality of sets of information as a child segment, and
the third condition includes that the memory section does not store the association information corresponding to the type of the device represented by the type information included in the acquired device data, and that the data type in the storage structure is different from the data type in the data structure.

8. The data mapping method according to claim 1, wherein
the association information represents association between the plurality of sets of information and the plurality of storage locations for a part of the plurality of sets of information.

9. The data mapping method according to claim 8, wherein
the storage structure and the data structure are hierarchical,
the data structure includes a plurality of hierarchies, and
the association information
makes the storage structure correspond to the data structure so as to storage locations in a number capable of storing the plurality of sets of information, and
regardless of the plurality of hierarchies, in one hierarchy related to the type of the device, associates the plurality of sets of information with the plurality of storage locations.

10. A data mapping system that determines a plurality of storage locations for respectively storing a plurality of sets of information of device data, wherein
the device data includes the plurality of sets of information related to a device and has a data structure configured to associate the plurality of sets of information with each other,
the plurality of sets of information includes type information representing a type of the device,
the data mapping system comprises a management section and an information aggregation section,
the management section includes a control section and a memory section,
the information aggregation section stores the device data by acquiring the plurality of sets of information from the device in advance,
the memory section stores association information,
the control section is capable of configuring, in the memory section, a storage section for storing the plurality of sets of information,
the storage section includes the plurality of storage locations for respectively storing the plurality of sets of information and has a storage structure for associating the plurality of storage locations with each other,
the association information associates the plurality of sets of information with the plurality of storage locations for each type of the device with respect to a part of the device,
the control section
acquires the device data from the information aggregation section,
when a first condition is satisfied, configures the storage section in the memory section based on the association information corresponding to the type of the device represented by the type information included in the acquired device data, and
when a second condition is satisfied, configures the storage section in the memory section based on the data structure included in the acquired device data,
the first condition includes that the memory section stores the association information corresponding to the type of the device represented by the type information included in the acquired device data, and
the second condition includes that the memory section does not store the association information corresponding to the type of the device represented by the type information included in the acquired device data.

11. A robot monitoring system that determines a plurality of storage locations for respectively storing a plurality of sets of information of device data, wherein
the device data includes the plurality of sets of information related to a device and has a data structure configured to associate the plurality of sets of information with each other,
the plurality of sets of information includes type information representing a type of the device,
the device is a plurality of robots,
the robot monitoring system comprises a management section, an information aggregation section, and a display section,
the management section includes a control section and a memory section,
the information aggregation section stores the device data by acquiring the plurality of sets of information from the device in advance,
the memory section stores association information,
the control section is capable of configuring, in the memory section, a storage section for storing the plurality of sets of information,
the storage section includes the plurality of storage locations for respectively storing the plurality of sets of information and has a storage structure for associating the plurality of storage locations with each other,
the association information associates the plurality of sets of information with the plurality of storage locations for each type of the device with respect to a part of the device,
the control section
acquires the device data from the information aggregation section,
when a first condition is satisfied, configures the storage section in the memory section based on the association information corresponding to the type of the device represented by the type information included in the acquired device data,
when a second condition is satisfied, configures the storage section in the memory section based on the data structure included in the acquired device data,
stores the plurality of sets of information in the storage section, and
displays a screen that is capable of monitoring states of the plurality of robots, the screen being generated based on the plurality of sets of information stored in the storage section, on the display section,
the first condition includes that the memory section stores the association information corresponding to the type of the device represented by the type information included in the acquired device data, and
the second condition includes that the memory section does not store the association information corresponding to the type of the device represented by the type information included in the acquired device data.
